(19) United States
(12) Patent Application Publication
(10) Pub. No.: US 2014/0279680 A1
(43) Pub. Date: Sep. 18, 2014

(54) SYSTEMS AND METHODS FOR PROVIDING ASSET-BACKED SECURITIES

(71) Applicant: TIPTREE ASSET MANAGEMENT COMPANY, LLC, New York, NY (US)

(72) Inventor: Christopher CONLEY, Darien, CT (US)

(73) Assignee: TIPTREE ASSET MANAGEMENT COMPANY, LLC, New York, NY (US)

(21) Appl. No.: 13/828,522

(22) Filed: Mar. 14, 2013

(51) Int. Cl. G06Q 40/06

(52) U.S. Cl. CPC G06Q 40/06
USPC 705/36 R

(57) ABSTRACT

Systems and methods are provided for creating and managing securities backed by assets from a variety of municipal jurisdictions. A cash flow determination module within a computing system receives cash flow information indicative of cash flows associated with a plurality of municipal securities. The plurality of municipal securities is associated with a plurality of municipal jurisdictions. A tranche requirements determination module within the computing system creates an investment program based on the cash flow information. An asset structuring module within the computing system causes the investment program to be provided to a multi jurisdictional municipal bond issuer, where the multi jurisdictional municipal bond issuer is authorized to issue municipal bonds for the plurality of securities associated with the plurality of jurisdictions.

### BACKGROUND

1. Technical Field

Disclosed systems and methods relate to providing asset backed securities.

2. Description of the Related Art

Financial institutions can collect a large amount of assets and sell them to investors as a new instrument. The new instrument is often referred to as an asset-backed security (“ABS”), and the underlying assets are often referred to as collateral assets. In one perspective, selling an ABS is a form of raising funds to buy assets. For example, financial institutions may want to buy certain assets, such as the collateral assets, as a form of investment, but may not have sufficient liquidity to buy the assets. In such cases, financial institutions can raise funds to buy the assets by selling a new instrument that is backed by the assets. Thus, selling an ABS is a form of raising funds to buy assets.

Financial institutions can create new instruments for investors by securitizing underlying collateral assets. Securitizing assets can involve aggregating assets into a pool, which may include assets from various municipal jurisdictions and of various kinds, and selling the aggregated assets to investors as an instrument. Financial institutions can benefit from aggregating the collateral assets into a pool for at least two reasons. First, the aggregated assets, also referred to as pooled assets, can collectively exhibit lower risk compared to individual assets in the pool. Second, small or illiquid assets, which may not be attractive to investors individually, can be converted into a new instrument that is more liquid and is more attractive to investors.

Financial institutions can further lower the risk of pooled assets through credit enhancement. Credit enhancement can involve segregation of the pooled assets into tranches where each tranche is associated with different credit characteristics. This way, the financial institutions can sell tranches using different amortization schedules, interest rates, rights, and/or security features.

Financial institutions can securitize the pooled assets (or tranches) as bonds. A bond is a financial instrument that represents the indebtedness of the bond issuer to the bond holder. The bond issuer is obliged to pay the bond holder the amount of the debt owed on the bond, also known as a principal, by a predetermined time, also known as a maturity. Depending on the terms of the bond, the bond issuer can also be obliged to pay interest on the principal, also known as interest. There are various types of bonds issued by various entities, including, but not limited to, government bonds, municipal bonds, corporate bonds, mortgage bonds, insurance bonds, surety bonds, and catastrophe bonds.

### SUMMARY

In accordance with the disclosed subject matter, systems and methods are provided for creating and managing securities backed by assets from a variety of municipal jurisdictions.

The disclosed subject matter includes a method. The method can include receiving, at a cash flow determination module within a computing system, cash flow information indicative of cash flows associated with a plurality of municipal securities, where the plurality of municipal securities is associated with a plurality of municipal jurisdictions. The method can also include creating, by a tranche requirements determination module within the computing system, an investment program based on the cash flow information. The method can further include causing, by an asset structuring module within the computing system, the investment program to be provided to a multi jurisdictional municipal bond issuer, where the multi jurisdictional municipal bond issuer is authorized to issue municipal bonds for the plurality of securities associated with the plurality of jurisdictions.

The disclosed subject matter includes a non-transitory computer readable medium. The non-transitory computer readable medium can include executable instructions operable to cause an apparatus to receive, through a cash flow determination module of the apparatus, cash flow information indicative of cash flows associated with a plurality of municipal securities, where the plurality of municipal securities is associated with a plurality of municipal jurisdictions. The non-transitory computer readable medium can also include executable instructions operable to cause the apparatus to create, through a tranche requirements determination module of the apparatus, an investment program based on the cash flow information. The non-transitory computer readable medium can further include executable instructions operable to cause the apparatus to cause, through an asset structuring module of the apparatus, the investment program to be provided to a multi jurisdictional municipal bond issuer, where the multi jurisdictional municipal bond issuer is authorized to issue municipal bonds for the plurality of municipal securities associated with the plurality of municipal jurisdictions.

The disclosed subject matter can include an apparatus. The apparatus can include one or more interfaces configured to provide communication with memory. The apparatus can also include a processor, in communication with the one or more interfaces. The processor can be configured to receive, through a cash flow determination module stored in the memory, cash flow information indicative of cash flows associated with a plurality of municipal securities, where the plurality of municipal securities is associated with a plurality of municipal jurisdictions. The processor can also be configured to create, through a tranche requirements determination module stored in the memory, an investment program based on the cash flow information. The processor can be further configured to cause, through an asset structuring module stored in the memory, the investment program to be provided to a multi jurisdictional municipal bond issuer, where the multi jurisdictional municipal bond issuer is authorized to issue municipal bonds for the plurality of municipal securities associated with the plurality of municipal jurisdictions.

In one aspect, the method, the non-transitory computer readable medium, or the apparatus can include steps, modules, or processor configured to pool the plurality of securities into a single pool of assets.

In one aspect, the method, the non-transitory computer readable medium, or the apparatus can include steps, modules, or processor configured to create a plurality of tranches with different payment requirements.

In one aspect, a first tranche of the plurality of tranches is configured to have a lower risk than a second tranche of the plurality of tranches.

In one aspect, the plurality of securities includes municipal obligations, where a first of the municipal obligations is associated with a first jurisdiction of the United States of America and a second of the municipal obligations is associated with a second jurisdiction of the United States of America.

In one aspect, the multi jurisdictional municipal bond issuer includes a municipal bond issuer that does not require a nexus between the plurality of securities and the state in which the municipal bond issuer resides.

In one aspect, the multi jurisdictional municipal bond issuer comprises the Public Finance Authority of Wisconsin.

In one aspect, the multi jurisdictional municipal bond issuer comprises a municipal bond issuer that requires a nexus between the plurality of securities and the state in which the municipal bond issuer resides.

In one aspect, the investment program is open-ended.

In one aspect, the investment program is static.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a block diagram of a computing system for creating an investment program in accordance with some embodiments of the disclosed subject matter.

FIG. 2 illustrates a diagram illustrating a process of creating asset-backed securities in accordance with some embodiments of the disclosed subject matter.

FIG. 3 illustrates a flow diagram illustrating a process of creating an investment program based on collateral assets from a variety of municipal jurisdictions in accordance with an embodiment of the disclosed subject matter.

FIG. 4 illustrates a process of the computing system for developing an investment program backed by the collateral assets in accordance with some embodiments of the disclosed subject matter.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

Financial institutions can benefit from securitizing collateral assets such as municipal obligations because unlike some financial instruments, municipal bonds can be sold to the general municipal bond market. The pooled assets can be securitized as municipal bonds using a municipal bond issuer. Unfortunately, a traditional municipal bond issuer has a jurisdictional limitation: a traditional municipal bond issuer can only issue bonds for assets and/or obligors having a nexus (i.e., a relationship) within its geographical jurisdiction. For example, the Dormitory Authority of the State of New York (DASNY) issues bonds for organizations that are located in the State of New York. Therefore, unless collateral assets originate from the state of New York, the DASNY cannot issue bonds based on those collateral assets. Such geographical jurisdictional limitations of municipal bond issuers can be problematic to financial institutions that have collateral assets from various municipal jurisdictions.

Financial institutions could address this issue by grouping assets based on their associated municipal jurisdictions and independently securitizing the groups of assets using separate municipal bond issuers. However, this process can be cumbersome because of a large number of municipal jurisdictions associated with the assets.

The disclosed systems and methods address this issue by using a multi-jurisdictional municipal bond issuer. A multi jurisdictional municipal bond issuer is a bond issuer that can issue a bond for assets from various municipal jurisdictions of and within the United States of America, regardless of which municipal jurisdictions the assets originate from, or whether or not assets have a nexus with the bond issuer. The disclosed systems and methods use the multi jurisdictional municipal bond issuer to issue municipal bonds that are backed by assets originating from various municipal jurisdictions. To do so, the disclosed systems and methods can create an investment program that structures the collateral assets as a single pool of assets or tranches, and provide the investment program to the multi-jurisdictional municipal bond issuer. Subsequently, the multi jurisdictional municipal bond issuer can issue municipal bonds based on the investment program. If the investment program includes a single pool of assets, the multi jurisdictional municipal bond issuer would issue municipal bonds for the single pool of assets; if the investment program includes tranches, then the multi jurisdictional municipal bond issuer would issue bonds for each of the tranches. The disclosed systems and methods can significantly reduce the burden and inefficiencies associated with grouping assets based on their associated municipal jurisdictions and independently securitizing the groups of assets using separate municipal bond issuers.

In some cases, the disclosed systems and methods can provide the investment program to a partnership trust, and request the partnership trust to issue, to the multi-jurisdictional municipal bond issuer, partnership trust certificates based on the investment program. This way, the multi jurisdictional municipal bond issuer can issue municipal bonds that are backed by the partnership trust certificates, which are in turn backed by the collateral assets. This approach can, in some cases, increase the efficiency of the investment program for certain preferential features, such as tax exemption features associated with the investment program.

In one aspect, the disclosed systems and methods can create a permanent, open-ended investment program to sell structured collateral assets (or equivalently, to finance the acquisition of collateral assets) where the collateral assets may be of different types originating from various municipal jurisdictions.

In some embodiments, the collateral assets can include municipal obligations from a variety of municipalities. For example, the collateral assets can include municipal obligations from Cambridge, Mass. and Columbus, Ohio. Municipal obligations can include debt that can be legally payable from general revenues of a municipal entity. The municipal obligations can be backed by the full faith and credit of the municipal entity, and, if the municipal entity is authorized to levy taxes, by those taxes. The municipal entity can include states, cities, counties, territories, and issuing authorities.

In other embodiments, the collateral assets can include instruments associated with a variety of sectors. For example, the collateral assets can include mortgage loans, car loans, corporate bonds, revenue bonds, municipal appropriations, leases, certificates of participation (COPs), or municipal obligations.

FIG. 1 is a block diagram of a computing system for creating an investment program in accordance with some embodiments of the disclosed subject matter. The block diagram 100 shows a computing system 102, which includes a processor 104, a memory 106, an asset structuring (AS) module 108, and interfaces 110.

The computing system 102 can transform collateral assets into an investment program suited to a multi jurisdictional municipal bond issuer. In particular, the computing system 102 can aggregate collateral assets, determine an investment program that is backed by the aggregated collateral assets, and cause the investment program to be provided to a multi jurisdictional municipal bond issuer either directly or indirectly via a partnership trust so that new instruments can be issued by the multi jurisdictional municipal bond issuer.

The computing system 102 can use the AS module 108 to compute the investment program from the cash flows of collateral assets. To compute the investment program, the AS module 108 can use a cash flow determination (CFD) module 112, a tranche requirements determination (TRD) module 114, and a stress test (ST) module 116.

In some embodiments, the AS module 108 aggregates the cash flow of collateral assets using the CFD module 112. The CFD module 112 computes the aggregate cash flow by combining the cash flow of the underlying collateral assets.

Once the CFD module 112 computes the aggregate cash flow, the AS module 108 can use the TRD module 114 and, optionally the ST module 116, to structure the investment program based on the aggregate cash flow. To this end, the TRD module 114 can receive the aggregate cash flow from the CFD module 112.

In some embodiments, the TRD module 114 can define the investment program simply as the aggregate cash flow received from the CFD module 112. In other embodiments, the TRD module 114 can define the investment program as tranches. For example, once the CFD module 112 computes the aggregate cash flow of collateral assets, the CFD module 112 can provide the aggregate cash flow to the TRD module 114. The TRD module 114 can subsequently define an investment program that includes tranches. In particular, the TRD module 114 can determine payment requirements associated with tranches, including a senior tranche, a subordinate tranche, and any mezzanine tranches. The payment requirements associated with tranches can include the payment of principal and interest, as well as any expenses associated with tranches. The TRD module 114 can ensure that payment requirements associated with the senior tranche, the subordinate tranche, and any mezzanine tranches can be satisfied by the cash flow of collateral assets. Subsequently, the TRD module 114 can provide the tranches to the ST module 116 to stress-test the determined tranches. The ST module 116 stress-tests the tranches based on various assumptions about default and recovery rates. Once the tranches pass the stress test, the AS module 108 completes the process of defining the investment program.

Once the investment program is defined, the AS module 108 can cause the investment program to be provided to a multi jurisdictional municipal bond issuer either directly or indirectly via a partnership trust. The modules 108, 112, 114, 116 can be implemented in software using the memory 106. The memory 106 can be a non-transitory computer readable medium, flash memory, a magnetic disk drive, an optical drive, a programmable read-only memory (PROM), a read-only memory (ROM), or any other memory or combination of memories. The software can run on a processor 104 capable of executing computer instructions or computer code. The processor 104 might also be implemented in hardware using an application specific integrated circuit (ASIC), programmable logic array (PLA), field programmable gate array (FPGA), or any other integrated circuit.

FIG. 1 shows a computing system 102 having modules that perform the above-described operations in accordance with some embodiments of the disclosed subject matter. In different embodiments, computing system 102 may include additional modules, fewer modules, or any other suitable combination of modules that perform any suitable operation or combination of operations.

The interface 110 provides an input and/or output mechanism to communicate over a network. The interface 110 enables communication with clients, as well as other network nodes in the communication network. The interface 110 can be implemented in hardware to send and receive signals in a variety of mediums, such as optical, copper, and wireless, and in a number of different protocols some of which may be non-transient.

The computing system 102 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The computing system 102 can include a desktop computer, a mobile computer, a tablet computer, a cellular device, a single server, or a network of servers, a farm of servers in a data center, or any computing systems that is capable of performing computation.

To appreciate the inventive computing system 102, it is helpful to discuss how the computing system 102 can be used to provide new financial instruments based on collateral assets associated with various municipal jurisdictions.

FIG. 2 illustrates a diagram illustrating a high level process of creating and selling asset-backed securities in accordance with some embodiments of the disclosed subject matter. The diagram includes a program manager 202 including the computing system 102, collateral assets 204, an investment program 206, and an instrument issuer 208.

Creating and selling asset-backed securities is a form of buying collateral assets 204 and reselling those assets in a different form, such as an investment program 206. In this process, the program manager 202 can use the computing system 102 to determine an investment program 206, based on the collateral assets 204, that would increase the expected positive return while reducing the risk (or probability) of negative return on the investment.

In some embodiments, the AS module 108 of the computing system 102 can use the CFD module 112 to create an investment program 206 by simply pooling the collateral assets into a single pool. In other embodiments, the AS module 108 of the computing system 102 can use the CFD module 112 and the TRD module 114 to create an investment program 206 that includes a plurality of “tranches” supported by the collateral assets. Tranches refer to a number of related securities that are offered as part of the same transaction. Each tranche can be viewed as a security backed by the collateral assets 204. In some embodiments, the investment program can indicate, for each tranche, one or more of the size of the investment (i.e., the total principal) to be made by investors, the interest (i.e., interest) on the principal to be paid to the investors, and a priority of the cash flows and rights of the tranches within the investment program.

The investment program 206 can be associated with a risk, which can be controlled using reserve funds associated with the investment program 206 and/or via investment by the program manager or other investor 202, as will be explained later. In some embodiments, each tranche can be associated with a different level of risk, based on the priority associated with the tranche within the investment program. Depending on the amount of risk associated with each tranche, a tranche may be referred to as a senior tranche, a mezzanine tranche, or a subordinate tranche. The senior tranche is characterized as the least risky tranche because it has the most senior claim (i.e., highest priority) on the cash flow of the investment program, whereas the subordinate tranche is characterized as the most risky tranche because it has the least senior claim (i.e., lowest priority) on the cash flow of the investment program. Any tranche that is riskier than the senior tranche, but is less risky compared to the subordinate tranche is referred to as a mezzanine tranche.

The TRD module 108 can structure the tranches so that in case the cash flow from the collateral assets is limited, senior tranche owners are compensated before any other tranche owners. For example, if the investment program 206 lacks cash flow to pay for all the payment requirements and expenses of the program, the cash flow of the investment program can be diverted to the senior tranche so that senior tranche owners are compensated first. Once each of the senior tranche payment requirements have been satisfied, the remaining cash flows are distributed to mezzanine tranche owners. Subordinate tranche owners are compensated only after fully compensating the mezzanine tranche owners. Under this payment structure, the subordinate tranche is the riskiest amongst the tranches in the investment program 206.

Once the AS module 108 completes the process of defining the investment program (e.g., the process of specifying tranches, confirming the expenses, and specifying reserve levels, as described further below), the AS module 108 can provide the investment program to the instrument issuer 208, and the instrument issuer 208 can issue instruments associated with the investment program. The issued instruments can be sold in a capital market to investors.

FIG. 3 illustrates a detailed flow diagram illustrating a process of creating an investment program based on a variety of assets from a variety of municipal jurisdictions in accordance with an embodiment of the disclosed subject matter. The diagram 300 includes a program manager system 202 including a computing system 102, cash flow information associated with collateral assets 304, program expenses 306, default and recovery assumptions 308, a multi jurisdictional municipal bond issuer system 310, a partnership trust 312, a market 314, and a credit enhancement system 316. Each type of collateral asset can be associated with a variety of municipal jurisdictions. For example, the cash flow from “municipal appropriations” can be generated by bonds, certificates of participation, or leases issued by municipalities from across the country.

The AS module 108 in the computing system 102 can create an investment program based on one or more of these factors. One exemplary factor includes the cash flow of collateral assets 304. The cash flow of collateral assets 304 can indicate movements of money into or out of associated assets. In particular, the cash flow of the collateral assets 304 can indicate the aggregate of the principal and interest payment schedules associated with the underlying assets. The magnitude of the cash flow of collateral assets 304 can depend on the magnitude of the principal and/or interest payments associated with the underlying assets.

Another exemplary factor includes program expenses 306 associated with creating and managing the investment program. The program expenses 306 can include non-recurring expenses, which may include one or more of legal expenses, underwriting expenses, rating agency expenses, and any other fees that can be paid at the initiation of the investment program. The program expenses 306 can also include on-going expenses associated with senior, mezzanine, and subordinate tranches. The on-going expenses can include expenses associated with a trustee, bond-issuing authorities, pool management, and rating agencies. In some cases, the investment program can be configured so that the on-going expenses are paid out of cash flows of the investment program.

Another exemplary factor includes the default and recovery assumptions 308 for the collateral assets. A collateral asset (or a collateral debt security) can be said to be in default if the entity issuing the collateral asset is unwilling to acknowledge the debt or is unable to make the required principal or interest payment. A collateral asset can be said to have recovered from default if the entity issuing the collateral asset acknowledges the debt and is able to make the required principal and interest payments. The default and recovery assumptions 308 for the collateral assets can include an assumed default rate and an assumed recovery rate. The assumed default rate can refer to the percentage of collateral assets that is assumed to default; and the assumed recovery rate can refer to the percentage of the defaulted assets that are assumed to recover. Furthermore, the default and recovery assumptions 308 can indicate an assumed default schedule, a time frame over which the collateral assets are assumed to default, and an assumed recovery schedule, a time frame over which the defaulted assets are assumed to recover.

Based on one or more of these factors, the AS module 108 can determine the investment program. In some embodiments, the AS module 108 can create the investment program by simply aggregating collateral assets using the CFD module 112. In other embodiments, the AS module 108 can define the investment program as tranches backed by the collateral assets using the CFD module 112 and the TRD module 114. Subsequently, the AS module 108 can provide the investment program to the multi jurisdictional municipal bond issuer system 310 either directly or indirectly via the partnership trust 312 to create a saleable instrument for the investment program. In some embodiments, the AS module 108 can provide the investment program to the multi jurisdictional municipal bond issuer system 310 either directly or indirectly via the partnership trust 312 via electronic communication systems, including an email system or a messenger system. In some embodiments, the AS module 108 can cause a user to provide the investment program via physical courier services or fax.

If the AS module 108 provides the investment program directly to the multi-jurisdictional municipal bond issuer system 310, the multi jurisdictional municipal bond issuer system 310 can issue instruments for the investment program. If the investment program is associated with a plurality of tranches, the multi jurisdictional municipal bond issuer system 310 can issue instruments for each tranche independently. An instrument associated with the senior tranche is called a senior instrument; an instrument associated with a mezzanine tranche is called a mezzanine instrument; and an instrument associated with the subordinate tranche is called a subordinate instrument. In some embodiments, the multi-jurisdictional municipal bond issuer system 310 can structure the instruments so that the interest payment dates, principal amortization schedule, and the final maturity of the instruments can, to the extent possible, correspond to the interest payment dates, principal amortization schedule, and final maturity date of the underlying collateral assets or partnership certificates. Instruments issued by the multi jurisdictional municipal bond issuer system 310 can include municipal bonds.

If the AS module 108 provides the investment program to the partnership trust 312, the partnership trust 312 can issue partnership trust certificates for the investment program. If the investment program is associated with a plurality of tranches, the partnership trust 312 can issue partnership trust certificates for each tranche independently. In some embodiments, the partnership trust 312 can structure the certificates so that the interest payment dates, principal amortization schedule, and the final maturity of the certificates can, to the extent possible, correspond to the interest payment dates, principal amortization schedule, and final maturity date of the associated assets. Subsequently, the partnership trust 312 can provide the trust certificates to the multi jurisdictional municipal bond issuer system 310, and the multi jurisdictional municipal bond issuer system 310 can issue bonds for the trust certificates. The multi jurisdictional municipal bond issuer system 310 can subsequently provide the issued bonds to the market 314 so that the issued bonds can be sold to the municipal bond market.

In some embodiments, the program manager 202 can retain securities associated with one or more tranches as an investment to the investment program. The retained tranche of securities may be the subordinate tranche. In other embodiments, the program manager 202 can purchase bonds associated with one or more tranches as an investment in the investment program. The purchased bonds can include the subordinate bonds.

Information relating to various factors, which are considered by the AS module 108 to develop the investment program, can be maintained in a storage system. The storage system can include one or more non-transient, non-tangible computer readable media. The non-transient computer readable media can include one or more of a local storage and a network storage. The local storage and the network storage can each include at least one physical, non-transitory storage medium.

The multi jurisdictional municipal bond issuer system 310 can include any entity that can issue instruments based on assets from various municipal jurisdictions. In particular, the multi jurisdictional municipal bond issuer system 310 can include a multi jurisdictional municipal bond issuer. The multi jurisdictional municipal bond issuer can issue municipal bonds, which can include conduit municipal bonds for public and private entities nationwide. Some multi jurisdictional municipal bond issuers 310 may only issue municipal bonds for collateral assets that have a nexus with the state in which the bond issuer resides. The nexus between the collateral assets and the state may be established when at least one of the collateral assets originates from the state. In some cases, the nexus between the collateral assets and the multi jurisdictional municipal bond issuer can be established by its enabling legislation. Thus, the circumstances in which the nexus can be established can vary amongst multi jurisdictional municipal bond issuers. In some cases, some multi jurisdictional municipal bond issuers 310 may issue municipal bonds for collateral assets that do not have a nexus with the state in which the bond issuer resides. Such multi jurisdictional municipal bond issuers can include the Public Finance Authority (“PFA”) of Wisconsin.

The partnership trust 312 can include any entity that can receive an investment program and issue partnership trust certificates corresponding to the received investment program.

In some embodiments, the multi jurisdictional municipal bond issuer system 310 can use a credit enhancement system 316 to enhance the credit associated with issued bonds. In some cases, the credit enhancement system 316 can provide credit enhancement, through a policy of municipal bond insurance, mortgage insurance, a surety bond, or bank letter of credit, to bonds issued by the multi jurisdictional municipal bond issuer system 310 so that the risk associated with the issued bonds can be reduced. In some embodiments, if the multi-jurisdictional municipal bond issuer system 310 uses a credit enhancement system 316 to enhance the credit of the issued bonds, the TRD module 114 of the computing system 102 can take this into account when determining the subordination level and/or the reserve level, as discussed below.

The computing system 102, the multi jurisdictional municipal bond issuer system 310, the partnership trust 312, the market 314, and the credit enhancement system 316 can communicate with one another using a communication network. For example, the computing system 102, the multi jurisdictional municipal bond issuer system 310, the partnership trust 312, the market 314, and the credit enhancement system 316 can communicate over an email system implemented on a communication network; the computing system 102, the multi-jurisdictional municipal bond issuer system 310, the partnership trust 312, the market 314, and the credit enhancement system 316 can also communicate over a fax system implemented on a communication network; and the computing system 102, the multi-jurisdictional municipal bond issuer system 310, the partnership trust 312, the market 314, and the credit enhancement system 316 can also communicate over a proprietary communication protocol implemented on a communication network.

The communication network can include a network or combination of networks that can accommodate data communication. For example, the communication network can include a local area network (LAN), a virtual private network (VPN) coupled to the LAN, a private cellular network, a private telephone network, a private computer network, a private packet switching network, a private line switching network, a private wide area network (WAN), a corporate network, a public cellular network, a public telephone network, a public computer network, a public packet switching network, a public line switching network, or a public wide area network (WAN). Such networks may be implemented with any number of hardware and software components, transmission media and network protocols.

FIG. 4 illustrates a process of an asset structuring module in a computing system for developing an investment program backed by collateral assets in accordance with some embodiments of the disclosed subject matter.

At a high level, the computing system 102 can receive, as input, desired characteristics of the senior tranche and any mezzanine tranches, and determine whether the desired characteristics of tranches can be supported by the underlying collateral assets. The desired characteristics of a tranche can include, for example, an interest rate schedule for the instrument associated with the tranche.

In step 402, the CFD module 112 in the AS module 108 can compute the aggregate cash flow of collateral assets. The CFD module 112 can compute the aggregate cash flow by combining the cash flow of each underlying collateral asset.

In subsequent steps, the AS module 108 can use the TRD module 114 to determine the investment program based on the aggregate cash flow. In some embodiments, the TRD module 114 can define the investment program simply as the aggregate cash flow received from the CFD module 112. In this case, the AS module 108 can skip steps 404-414, and go to step 416.

In other embodiments, the TRD module 114 can define the investment program as tranches. In such embodiments, the AS module 108 can proceed with step 404. In step 404, the TRD module 114 in the AS module 108 can determine the specifications of the senior tranche based on the aggregate cash flow. First, the TRD module 114 can calculate the senior tranche cash flow requirements. The senior tranche cash flow requirements can indicate a cash flow that is required to fund payment of principal and interest to the senior tranche owners. The senior tranche cash flow requirement can be computed based on the desired size of the senior tranche and the desired interest rate schedule of the senior tranche. In some cases, the desired interest rate schedule of the senior tranche may be provided by a user of the computing system 102. Second, the TRD module 114 can calculate the senior tranche payment requirements. The senior tranche payment requirements can be determined by combining the senior tranche cash flow requirements and program expenses other than subordinate program expenses.

In step 406, if the investment program also maintains mezzanine tranches, the TRD module 114 can determine the specifications of the mezzanine tranches. In particular, the TRD module 114 can calculate the mezzanine tranches cash flow requirements. The mezzanine tranches cash flow requirements can indicate a cash flow that is required to fund payment of principal and interest to the mezzanine tranches owners. The mezzanine tranches cash flow requirements can be computed based on the desired size of the mezzanine tranches and the desired interest rate schedule of the mezzanine tranches. In some cases, the desired interest rate schedule of the mezzanine tranches may be provided by a user of the computing system 102. The TRD module 114 can be programmed so that, if the investment program does not have enough funds to support cash flows of all tranches and program expenses, the principal payments and interest for the mezzanine tranches can be withheld until after the senior tranche payment requirements are fully satisfied. The TRD module 114 can subsequently determine the mezzanine tranches payment requirements, which can be determined by adding the mezzanine tranches cash flow requirements and expenses associated with the mezzanine tranches.

In some embodiments, the TRD module 114 can enhance the credit of the senior and mezzanine tranches. In particular, the TRD module 114 can enhance the credit of the senior and mezzanine tranches by altering the amount of investment made by the subordinate tranche investor and/or by altering the reserve level of the investment program.

For example, the TRD module 114 can structure the investment program so that the subordinate tranche is sized at a certain amount. If the TRD module 114 increases the amount of investment required, it reduces the amount of leverage, which subsequently reduces the probability that tranches invested in by third parties would default. This process can be referred to as subordination. Under subordination, the subordinate tranche investor is considered to bear the most risk of default in order to reduce the risk of default for other investors. In some embodiments, the subordinate tranche investor can be the program manager 202.

As another example, the TRD module 114 can structure the investment program so that the investment program maintains reserve funds. Reserve funds refer to funds that are designed to absorb losses and to provide liquidity for the investment program, in the event that cash flows generated by the collateral assets are insufficient to pay for the tranche payment requirements and expenses other than the subordinate tranche. In some cases, the reserve funds can be funded with a predetermined amount of money, received from the investors of the investment program instead of investing in the collateral assets. In other cases, the reserve funds can be created based on insurance policies, surety bonds, a bank letter of credit, and/or any other types of suitable assets. Maintaining reserve funds is different from subordination in that a subordinate tranche investor does not need to invest anything in order to maintain reserve funds.

Providing subordination and/or maintaining reserve funds can improve the credit of the senior and mezzanine tranches, and consequently the credit rating associated with the senior and mezzanine tranches. For example, the senior tranche may be associated with a AAA rating and mezzanine tranches may be associated with a AA rating, whereas the subordinate tranche may be associated with a B rating. The rating can be provided by a nationally-recognized rating agency, such as Standard & Poor's.

In some embodiments, if the multi jurisdictional municipal bond issuer 310 is configured to use the credit enhancement system 316, the TRD module 114 can take that into account to determine the subordination level and/or the amount of reserve funds. For example, if the target rating of a senior tranche is a AAA rating and if the multi jurisdictional municipal bond issuer 310 is configured to use the credit enhancement system 316, the TRD module 114 can provide subordination and/or maintain reserve funds so that the rating of the senior tranche without credit enhancement is, for example, a AA rating. Subsequently, when the multi jurisdictional municipal bond issuer 310 issues bonds for the senior tranche and enhances the credit of the issued bonds using the credit enhancement system 316, the rating associated with the issued bonds would become a AAA rating.

The TRD module 114 can vary the amount of subordination and/or the reserve fund to control the risk associated with the investment program. In some cases, the TRD module 114 can vary the amount of subordination and/or the reserve fund so that the senior and mezzanine tranches can obtain a desired credit rating. In some embodiments, the TRD module 114 can determine the desired amount of subordination or the reserve level based on a user input or based on default values stored in a storage system.

In step 408, the TRD module 114 can determine the excess cash flow available in each year. The excess cash flow can be determined by subtracting, from the total cash flow of collateral assets, the sum of (1) the senior tranche payment requirement, (2) the mezzanine tranche(s) payment requirement, and (3) subordinate program expenses.

In step 410, if there is no excess cash flow in any year, the AS module 108 can revise the subordination level and/or reserve level, and go to step 404 to revise the senior tranche and any mezzanine tranches. If not, the AS module 108 can compute the annual yield and the internal rate of return (IRR) for each tranche in the investment program and proceed to step 412.

In step 412, the ST module 116 of the AS module 108 can perform a stress test on the investment program to determine whether the investment program can withstand various potential losses. In particular, the ST module 116 is configured to determine (1) whether the amount of subordination and/or the reserve level is sufficient to withstand various potential losses, and if so, (2) whether the amount of subordination and/or the reserve level meets certain criteria.

To this end, the ST module 116 can compute the net cash flow of the collateral assets that takes into account the assumed default rate and the assumed recovery rate. The assumed default rate and the assumed recovery rate may be associated with one of the worst-case market conditions. In some cases, the ST module 116 can use the default rate and the recovery rate computed by a rating agency model required to achieve a certain rating. In other cases, the ST module 116 can use the default rate and the recovery rate computed by proprietary programs that takes into account various economic factors as well as asset-specific information.

In some embodiments, the ST module 116 can compute the net cash flow of the collateral assets as the total cash flow of the collateral assets adjusted by the default rate and the recovery rate. For example, the ST module 116 can compute the net cash flow of the collateral assets as the difference between (1) the sum of the total cash flow of the collateral assets and the assumed loss from default and (2) the assumed gain from recovery.

Subsequently, the ST module 116 can compute the excess cash flow under the stress condition. The excess cash flow under the stress condition can be determined by subtracting, from the net cash flow of the collateral assets, the sum of (1) the senior tranche payment requirement, (2) the mezzanine tranche(s) payment requirement, and (3) subordinate program expenses.

Then the ST module 116 can determine whether there is any deficiency in the investment program. A deficiency is a state in which the investment program lacks sufficient funds to pay any payment requirements and expenses other than the subordinate tranche payment requirements. For example, the deficiency is a state in which the investment program lacks sufficient funds to pay the senior payment requirements, mezzanine payment requirements or on-going subordinate expenses. If there is a deficiency at any point in time, the ST module 116 can apply the reserve funds in order to cure any deficiency. In some embodiments, curing the deficiency can include satisfying the senior payment requirements, mezzanine payment requirements, and on-going subordinate expenses. However, curing the deficiency may not include satisfying subordinate tranche's payment requirements.

If there are insufficient reserve funds to cure the deficiency, then the AS module 108 can revise the subordination level and/or reserve level, and go to step 404 to revise the senior tranche and any mezzanine tranches. For example, the interest rate schedule associated with the senior tranche and any mezzanine tranches can be revised.

However, if there are sufficient reserve funds to cure the deficiency, then the ST module 108 can determine whether the reserve level and/or the amount of subordination meets certain criteria. The criteria can include whether the reserve level and/or the amount of subordination is as small as possible while ensuring that there is sufficient reserve to cure any expected payment deficiency. In some embodiments, if the desired criteria are not satisfied, then the AS module 114 may revise the subordination level and/or reserve level, and go to step 404 to revise the senior tranche and any mezzanine tranches. This iterative process can allow the program manager or subordinate investor 202 to reduce initial investments.

In some embodiments, the ST module 108 may test various sets of default rate schedules and recovery rate schedules. In some cases, the number of sets of default rate schedules and recovery rate schedules tested during step 412 can be greater than or equal to two.

If the investment program passes the stress test in step 414, then in step 416, the AS module 108 can complete the process of defining (or structuring) the investment program and compute the expected annual yield and the expected internal rate of return associated with each tranche of the investment program.

In some embodiments, the AS module 108 can structure the assets so that the investment program is closed-ended, in which case the AS module 108 cannot add or remove assets in the investment program once the investment program is finalized. In other embodiments, the AS module 108 can structure the assets so that the investment program is open-ended, in which case the AS module 108 can add or remove assets in the investment program over time. In such open-ended investment program, the AS module 108 can add, to a tranche, only assets that satisfy the desired characteristic associated with the tranche, such as risk characteristics. In some embodiments, the AS module 108 may run the process of FIG. 4 to determine the characteristics of tranches after adding or removing assets from the investment program.

Subsequently, the AS module 108, or a user of the computing system 102, can provide the investment program to the multi jurisdictional municipal bond issuer system 310 either directly or indirectly via the partnership trust 312. In some cases, the AS module 108 can provide the investment program to the multi jurisdictional municipal bond issuer or the partnership trust via an electronic communication system, including an electronic mail (E-mail) system, a messenger system, or an encrypted communication system. In other cases, the AS module 108 can provide the investment program to a user of the computing system 102, and the user can deliver the investment program to the multi jurisdictional municipal bond issuer or the partnership trust via physical communication means, including telephones, fax, mail, fedex, or via hand-delivery.

In some embodiments, the collateral assets used by the AS module 108 can include securities. In some cases, the securities can include debt securities; in other cases, the securities can include equity securities. The securities can include municipal securities, such as municipal obligations. The securities can be associated with various municipal jurisdictions throughout the country. The municipal jurisdictions can include states, cities, counties, and territories, including the District of Columbia, of the United States of America, as well as the United States Federal Government. For example, as discussed above, the securities can include municipal obligations associated with various municipalities across the United States of America. The securities can include partnership trust certificates. In some cases, the securities can be tax-exempt; in other cases, the securities can be taxable.

In some embodiments, the securities can include obligations, bonds, notes, leases, certificates of participation, or any other instruments that evidence indebtedness, or partnership interests. The securities can include fixed rate debts or floating rate debts. These securities can be issued by entities that may not have any association with the jurisdiction in which the multi jurisdictional municipal bond issuer resides.

In some embodiments, the securities may also include pass-through trust certificates. The securities can also include any instrument secured by mortgages, general obligations, moral obligations, equipment, dedicated tax sources, annual appropriations, debt service reserve funds, gross revenue pledges, and net revenue pledges. The securities can be purchased in either the primary or the secondary markets.

In some embodiments, the securities can be associated with various sectors. One of the associated sectors can include nonprofits. For example, the securities associated with nonprofits can include instruments issued by healthcare institutions, such as acute healthcare hospital systems, acute healthcare standalone hospitals, acute healthcare rural hospitals, skilled nursing facilities, assisted living facilities, continuing care retirement communities, behavioral healthcare organizations, psychiatric hospitals, academic medical centers, federally qualified health centers, critical access hospitals, behavioral and primary health care providers, clinics, and long-term care facilities. As another example, the securities associated with nonprofits can include instruments issued by educational institutions, such as universities, colleges, private secondary schools, public secondary schools, religious or independent schools, charter schools, primary, technical and higher education institutions.

In some embodiments, the securities can be associated with a housing sector. For example, the securities can be associated with entities whose primary purpose is to own or capitalize multifamily or single family residential rental properties, and state and local housing authorities which issue municipal bonds in order to finance residential mortgage loans, including loans for affordable housing projects, in their states, as well as military housing bonds. In some embodiments, the securities can be associated with an infrastructure sector. For example, the securities can be associated with institutions related to power generation, utilities, roads, transportation, water, sewage and other aspects of public infrastructure. In some embodiments, the securities can be associated with a cultural sector. For example, the securities can be associated with museums, aquariums, zoos, botanical gardens, performing arts venues (such as opera, symphony, dance and theater) and public television and radio. In some embodiments, the securities can be associated with a research sector. For example, the securities can be associated with non-degree granting institutions whose primary purpose is to do research. In some embodiments, the securities can be associated with a philanthropic sector. For example, the securities can be associated with institutions whose primary purpose is to distribute funds to other entities, generally for humanitarian purposes. In some embodiments, the securities can be associated with a redevelopment/tax increment financing sector. For example, the securities can be associated with specially-created tax districts that generate specific tax revenue from a defined area surrounding a redevelopment project. In some embodiments, the securities can be associated with a service/advocacy sector. For example, the securities can be associated with organizations that provide community and social services to different constituent groups, including social service organizations, professional associations and religious organizations.

In some embodiments, the securities can be associated with various types of bonds. For example, the securities can include tobacco bonds, airport bonds, tax increment bonds, and/or Build America Bonds. As another example, the securities can include revenue bonds, which are used to finance municipal projects that generate revenue (a toll road or bridge, for example). Such revenue bonds can include multi-family housing revenue bonds, single-family housing revenue bonds, resource recovery revenue bonds, public power plants revenue bonds, transportation revenue bonds, and tax increment districts bonds.

In some embodiments, the program manager 202 can use the AS module 108 to provide an investment program in which the collateral assets include fixed rate, municipal leases (TELs) from various municipalities around the United States. These leases can be used to fund the acquisition and installation of energy efficiency upgrades for state and local government buildings and can be subject to annual appropriation by the municipality.

The program manager or subordinate investor 202 can finance the TELs by issuing senior and/or subordinate municipal bonds secured by the TELs: (1) senior bonds with a fixed stated interest rate and (2) subordinate bonds, which can receive a stated interest rate based on the amount of interest on the TELs, less the sum of the amount of interest on the senior bonds and on-going program expenses. The senior bonds can be secured by the TELs, the cash flows from the TELs, and a debt service reserve fund (i.e., a reserve fund). The term and amortization of the senior pool bonds can match the term and amortization of the underlying TELs. In some embodiments, the program manager 202 can purchase the subordinate bonds.

The investment program can be structured so that, in case the investment program is deficient, the cash flows of the collateral assets are configured to fund repayments in the following order: (1) senior bond interest and principal payments, senior fees including fees to the issuing authority, trustee, rating agency, and collateral manager, (2) mezzanine bond interest and principal payments, (3) repayment of the reserve if necessary, (4) repayment of the surplus/expense fund if necessary, (5) subordinate program expenses, and (6) payment of the subordinate bond interest payment. In this context, the surplus fund includes funds formed using excess cash flows of the investment program and can be considered as a cushion to provide payments for tranche payment requirements; the expense fund includes funds formed using excess cash flows of the investment program and can be considered as a cushion to provide payments for program expenses.

The number of securities in the investment program can vary from one investment program to another investment program. The number of securities can be significantly larger than the number of tranches in the investment program.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving, at a cash flow determination module within a computing system, cash flow information indicative of cash flows associated with a plurality of municipal securities, wherein the plurality of municipal securities is associated with a plurality of municipal jurisdictions;
creating, by a tranche requirements determination module within the computing system, an investment program based on the cash flow information; and
causing, by an asset structuring module within the computing system, the investment program to be provided to a multi jurisdictional municipal bond issuer, wherein the multi-jurisdictional municipal bond issuer is authorized to issue municipal bonds for the plurality of securities associated with the plurality of jurisdictions.

2. The method of claim 1, wherein creating the investment program comprises pooling the plurality of securities into a single pool of assets.

3. The method of claim 1, wherein creating the investment program comprises creating a plurality of tranches with different payment requirements.

4. The method of claim 3, wherein a first tranche of the plurality of tranches is configured to have a lower risk than a second tranche of the plurality of tranches.

5. The method of claim 1, wherein the plurality of securities comprises municipal obligations, wherein a first of the municipal obligations is associated with a first jurisdiction of the United States of America and a second of the municipal obligations is associated with a second jurisdiction of the United States of America.

6. The method of claim 1, wherein the multi jurisdictional municipal bond issuer comprises a bond issuer that does not require a nexus between the plurality of securities and a state in which the bond issuer resides.

7. The method of claim 6, wherein the multi jurisdictional municipal bond issuer comprises the Public Finance Authority of Wisconsin.

8. The method of claim 1, wherein the multi jurisdictional municipal bond issuer comprises a municipal bond issuer that requires a nexus between the plurality of securities and a state in which the municipal bond issuer resides.

9. The method of claim 1, wherein the investment program is open-ended.

10. A non-transitory computer readable medium comprising executable instructions operable to cause an apparatus to:
receive, through a cash flow determination module of the apparatus, cash flow information indicative of cash flows associated with a plurality of municipal securities, wherein the plurality of municipal securities is associated with a plurality of municipal jurisdictions;
create, through a tranche requirements determination module of the apparatus, an investment program based on the cash flow information; and
cause, through an asset structuring module of the apparatus, the investment program to be provided to a multi jurisdictional municipal bond issuer, wherein the multi-jurisdictional municipal bond issuer is authorized to issue municipal bonds for the plurality of municipal securities associated with the plurality of municipal jurisdictions.

11. The computer readable medium of claim 10, further comprising executable instructions operable to cause the apparatus to create a plurality of tranches with different payment requirements.

12. The computer readable medium of claim 10, wherein the plurality of municipal securities comprises municipal obligations, wherein a first of the municipal obligations is associated with a first jurisdiction of the United States of America and a second of the municipal obligations is associated with a second jurisdiction of the United States of America.

13. The computer readable medium of claim 10, wherein the multi jurisdictional municipal bond issuer comprises a bond issuer that does not require a nexus between the plurality of securities and a state in which the bond issuer resides.

14. The computer readable medium of claim 13, wherein the multi jurisdictional municipal bond issuer comprises the Public Finance Authority of Wisconsin.

15. The computer readable medium of claim 10, wherein the multi jurisdictional municipal bond issuer comprises a municipal bond issuer that requires a nexus between the plurality of securities and a state in which the municipal bond issuer resides.

16. An apparatus comprising:
one or more interfaces configured to provide communication with memory;
a processor, in communication with the one or more interfaces, configured to:
receive, through a cash flow determination module stored in the memory, cash flow information indicative of cash flows associated with a plurality of municipal securities, wherein the plurality of municipal securities is associated with a plurality of municipal jurisdictions;
create, through a tranche requirements determination module stored in the memory, an investment program based on the cash flow information; and
cause, through an asset structuring module stored in the memory, the investment program to be provided to a multi jurisdictional municipal bond issuer, wherein the multi jurisdictional municipal bond issuer is authorized to issue municipal bonds for the plurality of municipal securities associated with the plurality of municipal jurisdictions.

17. The apparatus of claim 16, wherein the plurality of municipal securities comprises municipal obligations, wherein a first of the municipal obligations is associated with a first jurisdiction of the United States of America and a second of the municipal obligations is associated with a second jurisdiction of the United States of America.

18. The apparatus of claim 16, wherein the investment program is open-ended.

19. The apparatus of claim 16, wherein the multi jurisdictional municipal bond issuer comprises a municipal bond issuer that does not require a nexus between the plurality of securities and a state in which the municipal bond issuer resides.

20. The apparatus of claim 16, wherein the multi jurisdictional municipal bond issuer comprises a municipal bond issuer that requires a nexus between the plurality of securities and a state in which the municipal bond issuer resides.
